(19) United States
(12) Patent Application Publication
(10) Pub. No.: US 2020/0171842 A1
(43) Pub. Date: Jun. 4, 2020

(54) POINTER AND INKJET PRINTER INCLUDING POINTER

(71) Applicant: Roland DG Corporation, Hamamatsu-shi (JP)

(72) Inventors: Masanori ISHIHARA, Hamamatsu-shi (JP); Arata MUKUNOKI, Hamamatsu-shi (JP); Motokuni KISHITA, Hamamatsu-shi (JP); Hironobu SUZUKI, Hamamatsu-shi (JP)

(21) Appl. No.: 16/695,510

(22) Filed: Nov. 26, 2019

(30) Foreign Application Priority Data
Nov. 29, 2018 (JP) 2018-223945
Nov. 29, 2018 (JP) 2018-223946

(51) Int. Cl. B41J 2/45; F21V 7/00

(52) U.S. Cl. CPC B41J 2/45; F21Y 2101/00; F21V 7/0058

(57) ABSTRACT

A pointer includes an LED device, a case, and a partition. The case houses the LED device. The case includes a light emission hole through which light from the LED device is emitted to an external space. The partition is located between the LED device and the light emission hole in the case. The partition includes a light passage hole through which the light from the LED device passes. The light passage hole and the light emission hole are disposed on a central axis of the LED device.

### CROSS REFERENCE TO RELATED APPLICATIONS

This application claims the benefit of priority to Japanese Patent Application No. 2018-223945 filed on Nov. 29, 2018 and Japanese Patent Application No. 2018-223946 filed on Nov. 29, 2018. The entire contents of these applications are hereby incorporated herein by reference.

### BACKGROUND OF THE INVENTION

### 1. Field of the Invention

The present invention relates to pointers and inkjet printers including pointers.

### 2. Description of the Related Art

A processing apparatus known in the related art, such as an inkjet printer, includes a bed on which an object to be processed (which will hereinafter be referred to as an “object”) is placed. Examples of such an object include a recording medium. In processing the object placed on the bed, the processing apparatus needs to preliminarily check the location of the object. The processing apparatus is provided with a pointer to apply small diameter light to the bed and/or the object. An operator moves, for example, the bed such that the light is applied from the pointer to a positioning reference point defined, for example, on the bed. This enables the processing apparatus to check the location of the object.

Laser light sources are usually used as light sources of pointers. Laser light sources, however, are relatively expensive. Thus, light-emitting diode (LED) devices that are more inexpensive than laser light sources are now finding use as light sources of pointers.

A pointer known in the related art includes an LED device serving as a light source, and a case in which the LED device is housed. The case is provided with a hole through which light from the LED device is emitted to the outside of the case. The light from such a pointer includes direct light and reflected light. The direct light is applied from the LED device to the outside of the case without being reflected inside the case. The reflected light is applied from the LED device to the outside of the case after being reflected inside the case. The reflected light will be applied to an area around a target region for direct light application. When the amount of reflected light is relatively large, the outline of the target region for direct light application will unfortunately be unclear owing to the reflected light. This makes it difficult to accurately apply the direct light from the pointer to a positioning reference point defined, for example, on the bed.

### SUMMARY OF THE INVENTION

Accordingly, preferred embodiments of the present invention provide pointers that are each able to make an outline of direct light clearer by reducing an amount of reflected light from a light source inside a case to an external space.

A pointer according to a preferred embodiment of the present invention includes an LED device, a case, and a first partition. The case houses the LED device. The case includes a light emission hole through which light from the LED device is emitted to an external space. The first partition is located between the LED device and the light emission hole in the case. The first partition divides the case into a first chamber and a second chamber. The first chamber houses the LED device. The second chamber is in communication with the light emission hole. The first partition includes a first light passage hole through which the light from the LED device passes. The first light passage hole and the light emission hole are disposed on a central axis of the LED device.

A pointer according to a preferred embodiment of the present invention includes the first light passage hole and the light emission hole disposed on the central axis of the LED device. The light from the LED device includes light that passes through the central axis. This light is relatively high in intensity. The high intensity light will be direct light that passes through the first light passage hole and the light emission hole and is then applied to the external space. The direct light thus has high intensity, making the outline of the direct light clearer. The light from the LED device needs to pass through the first partition before being emitted from the light emission hole to the external space. Light from an LED device (i.e., a light source) of a commonly used pointer includes light applied in a direction deviated from the central axis of the LED device. This light is reflected inside a case of the pointer, resulting in an increase in spot diameter.

A pointer according to a preferred embodiment of the present invention, however, may include the first partition that changes the direction of most of light reflected inside the case. Most of the light reflected inside the case is thus unable to pass through the first light passage hole of the first partition, while a portion of the reflected light passes through the first light passage hole. Accordingly, providing the first partition in the case significantly reduces the amount of reflected light applied to the outside of the case. If the reflected light is applied to an area around direct light applied to a recording medium or a bed on which the recording medium is placed, the outline of the direct light would not be unclear. This makes it possible to clearly recognize the outline of the direct light. Consequently, if the distance between the pointer and a surface to which the direct light is to be applied (e.g., the upper surface of the recording medium or the upper surface of the bed) changes, a pointer according to a preferred embodiment of the present invention would be able to keep a spot diameter unchanged unlike a conventional pointer including no partition.

Preferred embodiments of the present invention provide pointers that are each able to make the outline of direct light clearer by reducing the amount of reflected light from a light source inside a case to an external space.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a perspective view of a printer according to a first preferred embodiment of the present invention.

FIG. 2 is a perspective view of the printer according to the first preferred embodiment of the present invention, with its body case removed therefrom.

FIG. 3 is a cross-sectional view of the printer according to the first preferred embodiment of the present invention.

FIG. 4 is a schematic bottom view of a portion of an ink head unit according to the first preferred embodiment of the present invention.

FIG. 5 is a partially see-through perspective view of a pointer according to the first preferred embodiment of the present invention.

FIG. 6 is a cross-sectional perspective view of the pointer taken along the line VI-VI in FIG. 5.

FIG. 7 is a diagram illustrating optical paths for the pointer according to the first preferred embodiment of the present invention.

FIG. 8 is a side view of the pointer according to the first preferred embodiment of the present invention and its adjacent component.

FIG. 9A is a plan view of the printer according to the first preferred embodiment of the present invention, illustrating how direct light is applied from the pointer to a print start point on a print region.

FIG. 9B is a plan view of the printer according to the first preferred embodiment of the present invention, illustrating how direct light is applied from the pointer to a print end point on the print region.

FIG. 10A is a plan view of a printer known in the related art, illustrating how direct light is applied from a pointer to a print start point on a print region.

FIG. 10B is a plan view of the printer known in the related art, illustrating how direct light is applied from the pointer to a print end point on the print region.

FIG. 11A is a cross-sectional view of a variation of a partition of the pointer.

FIG. 11B is a cross-sectional view of another variation of the partition of the pointer.

FIG. 11C is a cross-sectional view of still another variation of the partition of the pointer.

FIG. 11D is a cross-sectional view of yet another variation of the partition of the pointer.

FIG. 11E is a cross-sectional view of still yet another variation of the partition of the pointer.

FIG. 12 is a diagram illustrating optical paths for a pointer according to a second preferred embodiment of the present invention.

FIG. 13 is a diagram illustrating optical paths for a pointer according to a third preferred embodiment of the present invention.

FIG. 14 is a side view of a pointer according to a fourth preferred embodiment of the present invention.

FIG. 15 is an exploded perspective view of the pointer according to the fourth preferred embodiment of the present invention.

FIG. 16 is a cross-sectional view of a second case of the pointer according to the fourth preferred embodiment of the present invention.

FIG. 17 is a bottom view of the pointer according to the fourth preferred embodiment of the present invention.

FIG. 18 is a perspective view of a plate according to the fourth preferred embodiment of the present invention.

FIG. 19 is a perspective view of a porous member according to the fourth preferred embodiment of the present invention.

FIG. 20 is a side view of a pointer according to a fifth preferred embodiment of the present invention.

### DETAILED DESCRIPTION OF THE PREFERRED EMBODIMENTS

Pointers according to preferred embodiments of the present invention and inkjet printers (hereinafter each referred to as a “printer”) that are processing apparatuses including the pointers will be described below with reference to the drawings. The preferred embodiments described below are naturally not intended to limit the present invention in any way. Components or elements having the same functions are identified by the same reference signs, and description thereof will be simplified or omitted when deemed redundant.

### First Preferred Embodiment

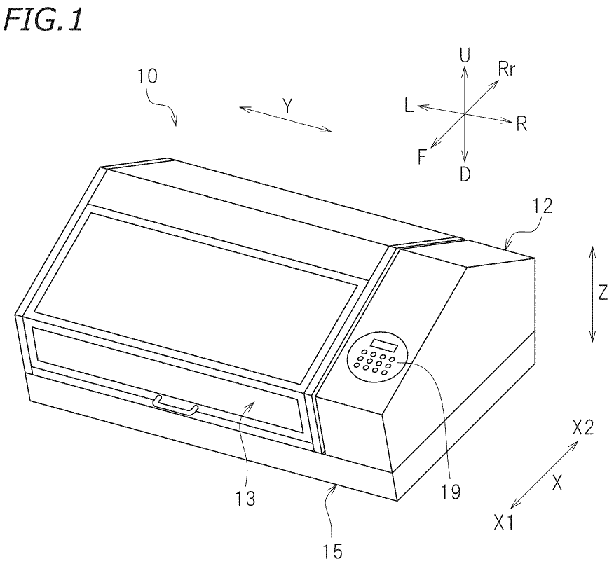

FIG. 1 is a perspective view of a printer 10 according to a first preferred embodiment of the present invention. As used herein, the term “forward” refers to a direction away from the rear of the printer 10 and toward an operator facing the front of the printer 10, and the term “rearward” refers to a direction away from the operator facing the front of the printer 10 and toward the rear of the printer 10. The terms “right”, “left”, “up”, and “down” respectively refer to right, left, up, and down with respect to the operator facing the front of the printer 10. The reference signs F, Rr, R, L, U, and D in the drawings respectively represent front, rear, right, left, up, and down. The reference sign Y in the drawings represents a main scanning direction. In the present preferred embodiment, the main scanning direction Y is a right-left direction. The reference sign X in the drawings represents a sub-scanning direction. In the present preferred embodiment, the sub-scanning direction X is a front-rear direction. The sub-scanning direction X is perpendicular or substantially perpendicular to the main scanning direction Y in a plan view. The reference sign Z in the drawings represents an up-down direction. The rear side of the printer 10 will be referred to as an “upstream side”. The front side of the printer 10 will be referred to as a “downstream side”. In the present preferred embodiment, a direction from the upstream side to the downstream side will be referred to as a “direction X1”, and a direction from the downstream side to the upstream side will be referred to as a “direction X2”. These directions are defined merely for the sake of convenience of description and do not limit in any way how the printer 10 may be installed or how the present invention may be practiced.

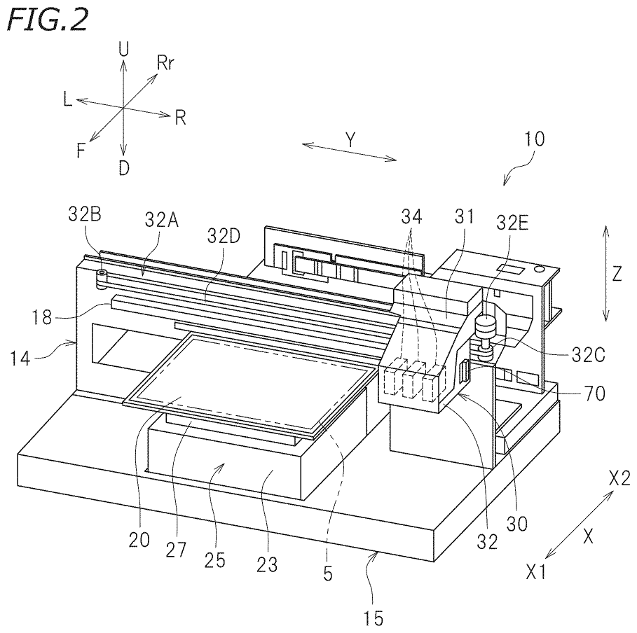

The printer 10 is an inkjet printer. The printer 10 is a “large printer” that is longer in the main scanning direction Y than printers for home use. The printer 10 is, for example, a business-use printer. In the present preferred embodiment, the printer 10 prints an image on a recording medium 5 (see FIG. 2).

The recording medium 5 is, for example, recording paper. The recording medium 5, however, is not limited to recording paper. Examples of the recording medium 5 include: a sheet made of a resin material, such as polyvinyl chloride (PVC) or polyester; and a relatively thick plate, such as a metallic plate made of metal (e.g., aluminum or iron), a glass plate, or a wood plate. The recording medium 5 is an example of an object to be processed (which will hereinafter be referred to as an “object”).

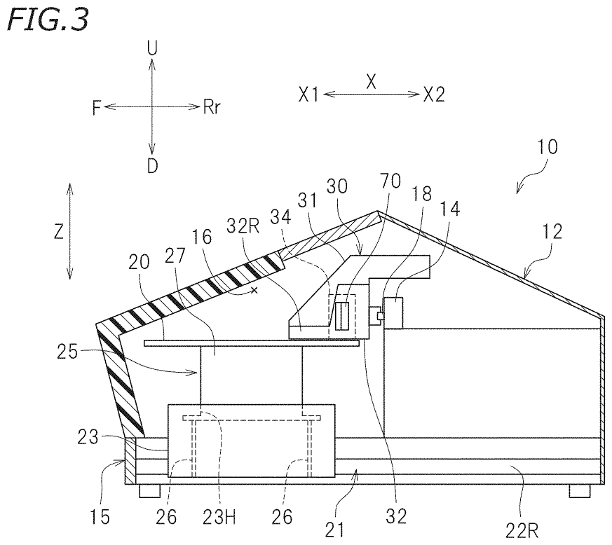

As illustrated in FIGS. 1 and 2, the printer 10 includes a body case 12, a support base 15, an operation panel 19, a table 20, an ink head unit 30, and a pointer 70. The table 20 is an example of a bed. The body case 12 has a box shape. The front portion of the body case 12 is provided with a front cover 13. The front cover 13 is able to open and close the body case 12. The support base 15 is attached to the lower portion of the body case 12. The support base 15 supports the body case 12. As illustrated in FIG. 2, the table 20 is disposed above the support base 15. As illustrated in FIG. 3, the ink head unit 30 is disposed inside the body case 12. Specifically, the ink head unit 30 is disposed in an inner space 16 defined by the body case 12 and the support base 15. The ink head unit 30 is disposed above the table 20. The ink head unit 30 includes ink heads 34, a case 31, and a head carriage 32 on which the ink heads 34 are mounted. The head carriage 32 is an example of a carriage.

As illustrated in FIG. 2, the printer 10 includes a body frame 14. The body frame 14 is provided inside the body case 12. The body frame 14 extends in the main scanning direction Y. At least a portion of the body frame 14 is disposed above the table 20. The body frame 14 is supported by the support base 15. The printer 10 includes a guide rail 18. The guide rail 18 is provided on the body frame 14. The guide rail 18 extends in the main scanning direction Y. The guide rail 18 extends along the front surface of the body frame 14. The guide rail 18 is in engagement with the head carriage 32 of the ink head unit 30 such that the head carriage 32 is slidable along the guide rail 18. The head carriage 32 is reciprocated in the main scanning direction Y along the guide rail 18 by a carriage conveyor 32A. The case 31 is attached to the head carriage 32. The carriage conveyor 32A is not limited to any particular configuration or structure. The carriage conveyor 32A includes a left pulley 32B, a right pulley 32C, an endless belt 32D, and a head carriage motor 32E. The left pulley 32B is provided leftward of the left end of the guide rail 18. The right pulley 32C is provided rightward of the right end of the guide rail 18. The belt 32D is wound around the left pulley 32B and the right pulley 32C. The right pulley 32C is connected with the head carriage motor 32E. Alternatively, the head carriage motor 32E may be connected to the left pulley 32B. In the present preferred embodiment, driving the head carriage motor 32E rotates the right pulley 32C so as to cause the belt 32D to run between the left pulley 32B and the right pulley 32C.

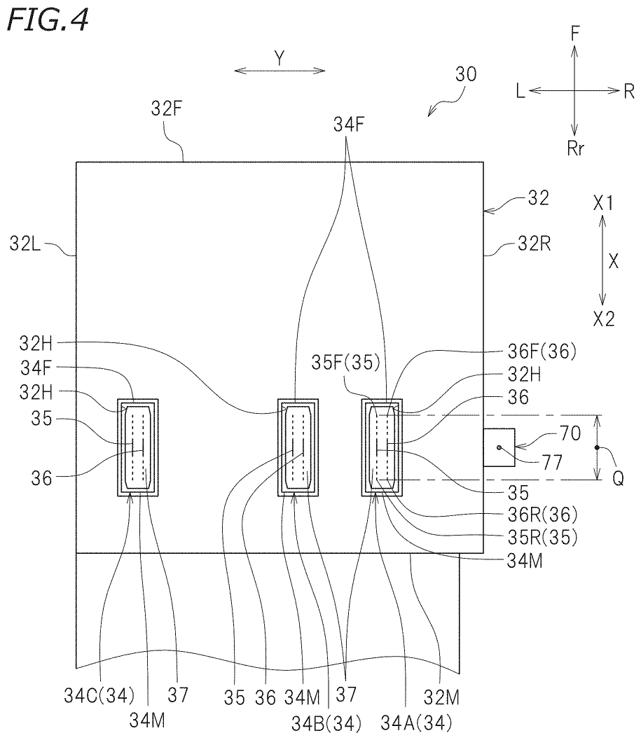

As illustrated in FIG. 4, the ink heads 34 of the ink head unit 30 include a first ink head 34A, a second ink head 34B, and a third ink head 34C. The first to third ink heads 34A to 34C are each attached to an associated one of openings 32H defined in the head carriage 32. The first to third ink heads 34A to 34C are housed in the case 31 (see FIG. 2). The first to third ink heads 34A to 34C are movable in the main scanning direction Y along the guide rail 18 together with the head carriage 32. The length of each of the first to third ink heads 34A to 34C measured in the sub-scanning direction X is longer than the length of each of the first to third ink heads 34A to 34C measured in the main scanning direction Y. The first to third ink heads 34A to 34C are similar in shape and size. Each of the first to third ink heads 34A to 34C includes a plurality of first nozzles 35 arranged in the sub-scanning direction X, a plurality of second nozzles 36 arranged in the sub-scanning direction X, and a nozzle surface 37 on which the first and second nozzles 35 and 36 are defined. The inside of each of the first and second nozzles 35 and 36 is placed under a negative pressure (i.e., a pressure lower than atmospheric pressure). Because the first and second nozzles 35 and 36 are very small, the first and second nozzles 35 and 36 are partially indicated by straight lines in FIG. 4. The first and second nozzles 35 and 36 of the first to third ink heads 34A to 34C discharge ink onto the recording medium 5 placed on the table 20. Examples of the ink include photo-curable ink. In the present preferred embodiment, the number of ink heads 34 included in the printer 10 is three. Alternatively, the printer 10 may include any other suitable number of ink heads 34. Although each ink head 34 includes two types of nozzles (i.e., the first nozzles 35 and the second nozzles 36), each ink head 34 may alternatively include a single type of nozzle or three or more types of nozzles.

As illustrated in FIG. 2, the recording medium 5 is placed on the table 20. The table 20 has a rectangular shape such that the length of the table 20 measured in the sub-scanning direction X is shorter than the length of the table 20 measured in the main scanning direction Y. Alternatively, the length of the table 20 measured in the sub-scanning direction X may be longer than the length of the table 20 measured in the main scanning direction Y, or the length of the table 20 measured in the sub-scanning direction X may be equal to the length of the table 20 measured in the main scanning direction Y. As illustrated in FIG. 3, the table 20 is disposed below the guide rail 18. The table 20 is disposed below the ink head unit 30. The first and second nozzles 35 and 36 of the first to third ink heads 34A to 34C discharge ink onto the recording medium 5 (see FIG. 2) placed on the table 20. The table 20 is movable in the sub-scanning direction X by a first conveyor 21 (which will be described below). The table 20 is movable in the up-down direction Z by a second conveyor 25 (which will be described below).

As illustrated in FIG. 3, the printer 10 includes the first conveyor 21. The first conveyor 21 is an example of a conveyor. The first conveyor 21 is housed in the support base 15. The first conveyor 21 includes a right slide rail 22R, a left slide rail (not illustrated), a table carriage 23, and a first driving motor (not illustrated). The right slide rail 22R and the left slide rail are provided in the support base 15. The right slide rail 22R and the left slide rail each extend in the sub-scanning direction X. The right slide rail 22R and the left slide rail guide movement of the table carriage 23 in the sub-scanning direction X. The table carriage 23 is in slidable engagement with the right slide rail 22R and the left slide rail. The table carriage 23 has a box shape. The table carriage 23 is provided with an opening 23H facing upward. The first driving motor is connected to the table carriage 23. Rotating the first driving motor enables the table carriage 23 to move in the sub-scanning direction X along the right slide rail 22R and the left slide rail. The first conveyor 21 is thus able to move the table 20 in the sub-scanning direction X. In other words, the first conveyor 21 is able to move the recording medium 5 (which is placed on the table 20) in the sub-scanning direction X.

As illustrated in FIG. 3, the printer 10 includes the second conveyor 25. The second conveyor 25 is housed in the table carriage 23 of the first conveyor 21. The second conveyor 25 includes a plurality of guide columns 26, a support case 27, and a second driving motor (not illustrated). The guide columns 26 extend in the up-down direction Z. The guide columns 26 are provided in the table carriage 23 of the first conveyor 21. The guide columns 26 guide movement of the support case 27 in the up-down direction Z. The support case 27 supports the table 20. The table 20 is secured to the upper portion of the support case 27. The support case 27 is in slidable engagement with the guide columns 26. The support case 27 has a box shape. The support case 27 is movable in the up-down direction Z relative to the table carriage 23. The second driving motor is connected to the support case 27. Rotating the second driving motor enables the support case 27 to move in the up-down direction Z along the guide columns 26.

As illustrated in FIG. 1, the operation panel 19 is provided on the body case 12. Specifically, the operation panel 19 is provided on the right portion of the body case 12. The operation panel 19 is disposed rightward of the table 20. The operation panel 19 is disposed rightward of the front cover 13. Through the operation panel 19, the operator makes settings and/or enters data for image printing. Although not illustrated in detail, the operation panel 19 includes a display screen and entry button(s). The display screen presents printing-related information, such as a print type, a resolution, a print status, and a print region setting. The entry button(s) is/are used to enter the printing-related information.

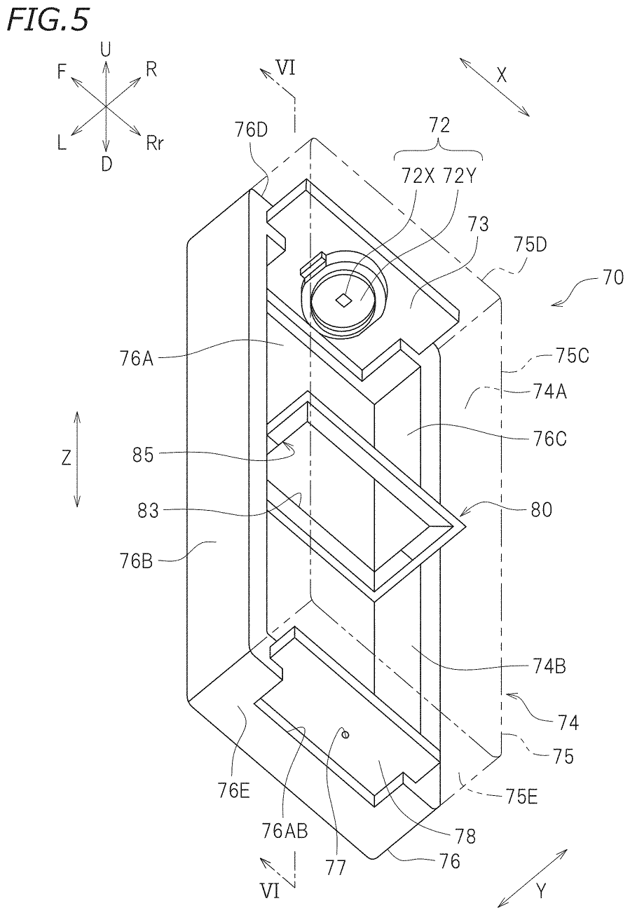

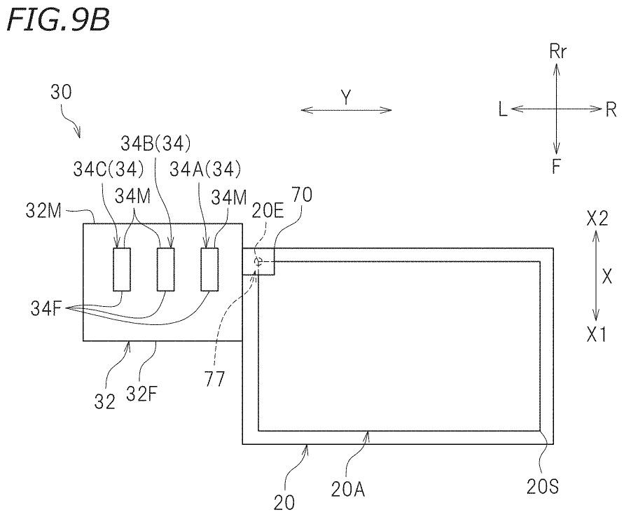

The pointer 70 applies light to positioning reference points defined on the table 20. The positioning reference points are, for example, a print start point 20S (see FIG. 9A) and a print end point 20E (see FIG. 9B). The pointer 70 applies light to the positioning reference points so as to enable the printer 10 to check a print region 20A (see FIG. 9A). As illustrated in FIG. 2, the pointer 70 is provided on the ink head unit 30. The pointer 70 is attached to the head carriage 32 (see FIG. 2). FIG. 5 is a partially see-through perspective view of the pointer 70. In FIG. 5, a first case 75 (which will be described below) is transparently illustrated such that the inner structure of the pointer 70 is visible. The first case 75 is indicated by the chain double-dashed lines. As illustrated in FIG. 5, the pointer 70 includes a light-emitting diode (LED) device 72, a case 74, and a partition 80. The case 74 includes the first case 75 and a second case 76.

As illustrated in FIG. 5, the LED device 72 is housed in the case 74. The LED device 72 according to the present preferred embodiment includes an LED chip 72X and a lens 72Y covering the LED chip 72X. The LED device 72 is disposed in a first chamber 74A (which will be described below). The LED device 72 is attached to an LED substrate 73. The LED device 72 attached to the LED substrate 73 is further attached to the first and second cases 75 and 76 (which will be described below) of the case 74. The LED device 72 applies, for example, red light. In the present preferred embodiment, the LED device 72 is housed in the case 74 such that the LED device 72 applies light downward.

As illustrated in FIG. 5, the case 74 has a cuboid shape. The case 74 extends in the up-down direction Z. The length of the case 74 measured in the up-down direction Z is longer than the length of the case 74 measured in the sub-scanning direction X. The first and second cases 75 and 76 of the case 74 are each made of, for example, aluminum. Alternatively, the first and second cases 75 and 76 of the case 74 may each be made of a metal material other than aluminum or a resin material.

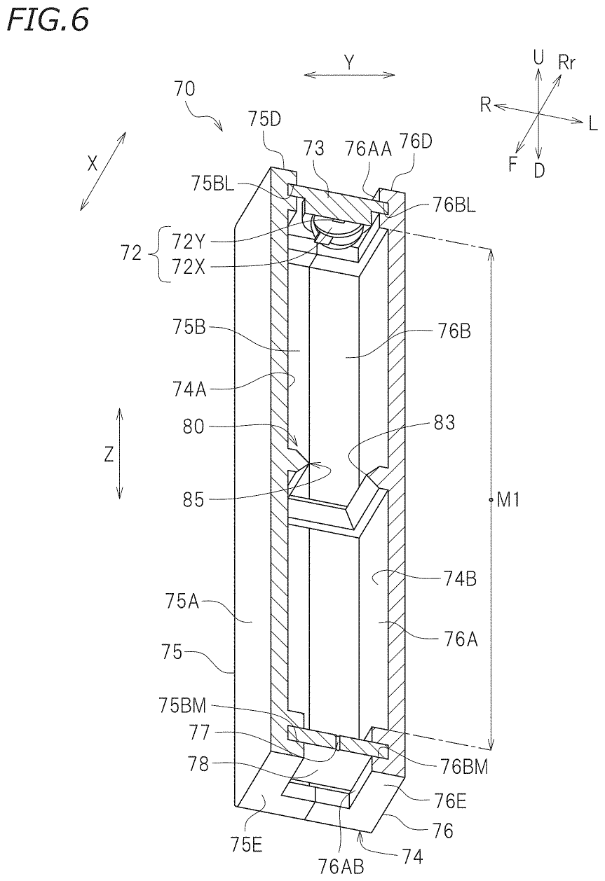

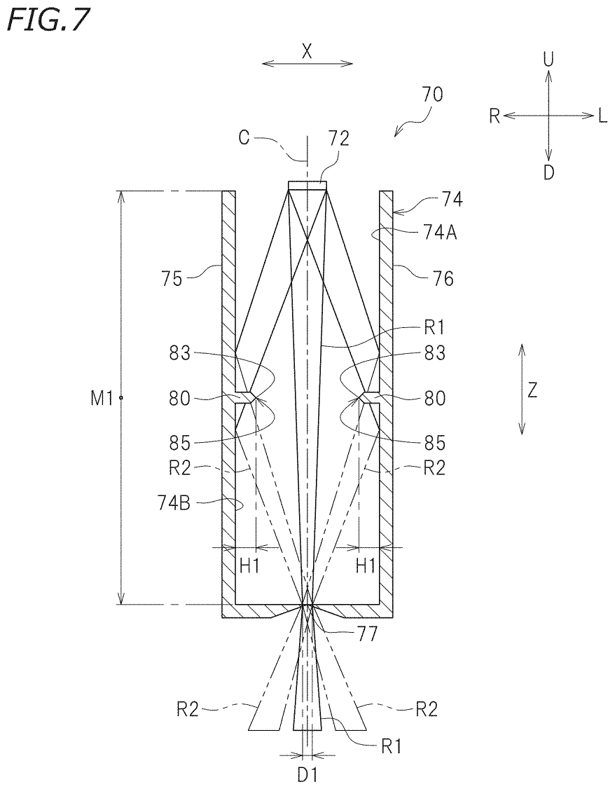

As illustrated in FIG. 5, the first case 75 includes a right wall 75A (see FIG. 6), a front wall 75B (see FIG. 6), a rear wall 75C, an upper wall 75D, and a lower wall 75E. As illustrated in FIG. 6, the right wall 75A extends in the up-down direction Z. The front wall 75B extends leftward from the front end of the right wall 75A. As illustrated in FIG. 5, the rear wall 75C extends leftward from the rear end of the right wall 75A. The rear wall 75C faces the front wall 75B. The upper wall 75D extends leftward from the upper end of the right wall 75A. The lower wall 75E extends leftward from the lower end of the right wall 75A. The lower wall 75E faces the upper wall 75D. The first case 75 is provided with a first engagement groove 75BL (see FIG. 6) in engagement with the LED substrate 73. The first case 75 is provided with a second engagement groove 75BM in engagement with a plate 78. The plate 78 is provided with a light emission hole (see also FIG. 7) through which light from the LED device 72 is emitted to an external space (i.e., to the outside of the case 74). The second engagement groove 75BM is located below the first engagement groove 75BL. The light emission hole 77 is disposed on a central axis C (see FIG. 7) of the LED device 72. The light emission hole 77 passes through the plate 78 in the up-down direction Z. The light emission hole 77 is defined in the center of the plate 78.

As illustrated in FIG. 5, the second case 76 includes a left wall 76A, a front wall 76B, a rear wall 76C, an upper wall 76D, and a lower wall 76E. The left wall 76A extends in the up-down direction Z. With the first case 75 and the second case 76 secured to each other, the left wall 76A of the second case 76 faces the right wall 75A of the first case 75. The front wall 76B extends rightward from the front end of the left wall 76A. The rear wall 76C extends rightward from the rear end of the left wall 76A. The rear wall 76C faces the front wall 76B. The upper wall 76D extends rightward from the upper end of the left wall 76A. The lower wall 76E extends rightward from the lower end of the left wall 76A. The lower wall 76E faces the upper wall 76D. As illustrated in FIG. 6, the second case 76 is provided with a first engagement groove 76BL in engagement with the LED substrate 73. The second case 76 is provided with a second engagement groove 76BM in engagement with the plate 78. The second engagement groove 76BM is located below the first engagement groove 76BL.

As illustrated in FIG. 6, the case 74 is provided with an opening 76AA that allows passage of wiring (not illustrated) connected to the LED substrate 73. The opening 76AA is defined by the upper wall 75D of the first case 75 and the upper wall 76D of the second case 76. The opening 76AA is located above the LED substrate 73. The case 74 is provided with an opening 76AB. Light that has passed through the light emission hole 77 is then emitted to the external space through the opening 76AB. The opening 76AB is defined by the lower wall 75E of the first case 75 and the lower wall 76E of the second case 76. The opening 76AB is located below the plate 78.

As illustrated in FIG. 5, the partition 80 is provided in the case 74. The partition 80 is disposed between the LED device 72 and the light emission hole 77. The partition 80 is provided below the LED device 72. The partition 80 is provided above the light emission hole 77. As illustrated in FIG. 6, the partition 80 is located at an intermediate position M1 between the LED device 72 and the light emission hole 77. Alternatively, the partition 80 may be located above the intermediate position M1 (i.e., at a position closer to the LED device 72 than the intermediate position M1). The partition 80 divides the case 74 into the first chamber 74A and a second chamber 74B. The LED device 72 is housed in the first chamber 74A. The second chamber 74B is in communication with the light emission hole 77. The second chamber 74B is located below the first chamber 74A. The partition 80 is provided with a light passage hole 85. The light from the LED device 72 passes through the light passage hole 85. The light passage hole 85 is larger than the light emission hole 77. As illustrated in FIG. 7, the light passage hole 85 is disposed on the central axis C of the LED device 72. The partition 80 is made of, for example, aluminum.

As illustrated in FIG. 6, the partition 80 according to the present preferred embodiment has a protruding shape. The partition 80 extends toward the central axis C of the LED device 72 in a direction perpendicular or substantially perpendicular to the central axis C of the LED device 72. The partition 80 protrudes toward the central axis C from the right wall 75A, the front wall 75B, and the rear wall 75C of the first case 75 and from the left wall 76A, the front wall 76B, and the rear wall 76C of the second case 76. As illustrated in FIG. 6, the light passage hole 85 is defined by an extremity 83 of the partition 80. The light passage hole 85 according to the present preferred embodiment has a rectangular shape. Alternatively, the light passage hole 85 may have a circular shape.

As illustrated in FIG. 7, the light from the LED device 72 includes direct light R1 and one-time reflected light R2. The direct light R1 is not reflected inside the case 74. The one-time reflected light R2 is reflected once inside the case 74. The partition 80 prevents the one-time reflected light R2 from being emitted to the outside of the case 74 through the light emission hole 77 by reflecting the one-time reflected light R2 in a direction that is not toward the light emission hole 77. A length H1 of protrusion of the partition 80 from the inner wall of the case 74 is set such that the partition 80 allows the direct light R1 to be emitted to the outside of the case 74 through the light emission hole 77 but prevents the one-time reflected light R2 from being emitted to the outside of the case 74 through the light emission hole 77. In one example, the length H1 of protrusion of the partition 80 may be longer than a diameter D1 of the light emission hole 77 so as to prevent the one-time reflected light R2 from being emitted to the outside of the case 74 through the light emission hole 77. Because the one-time reflected light R2 is brighter than other reflected light, the partition 80 precludes the one-time reflected light R2 from being emitted to the outside of the case 74 through the light emission hole 77. This prevents the one-time reflected light R2 from making the outline of the direct light R1 unclear.

As illustrated in FIG. 3, the pointer 70 is attached to a right side surface 32R of the head carriage 32. In one example, the pointer 70 is disposed to overlap with the ink heads 34 when viewed in the main scanning direction Y. Alternatively, the pointer 70 may be attached to a left side surface 32L (see FIG. 4) of the head carriage 32. The right side surface 32R of the head carriage 32 is located adjacent to the operation panel 19 (see FIG. 1) in the main scanning direction Y (i.e., adjacent to the right pulley 32C). The left side surface 32L of the head carriage 32 is located opposite to the operation panel 19 in the main scanning direction Y (i.e., opposite to the right pulley 32C). The right side surface 32R is an example of a first side surface. The left side surface 32L is an example of a second side surface.

As illustrated in FIG. 4, the pointer 70 (or more specifically, the light emission hole 77) is disposed upstream of a downstream end 32F of the head carriage 32 in the sub-scanning direction X. The pointer 70 is disposed to overlap with the head carriage 32 when viewed in the main scanning direction Y. In the present preferred embodiment, the pointer 70 (or more specifically, the light emission hole 77) is disposed rearward of the downstream end 32F of the head carriage 32. The pointer 70 (or more specifically, the light emission hole 77) is disposed upstream of a downstream end 34F of each ink head 34 in the sub-scanning direction X. In the present preferred embodiment, the pointer 70 (or more specifically, the light emission hole 77) is disposed rearward of the downstream end 34F of each ink head 34. The first nozzles 35 include most upstream nozzles 35R in the sub-scanning direction X and most downstream nozzles 35F in the sub-scanning direction X. The second nozzles 36 include most upstream nozzles 36R in the sub-scanning direction X and most downstream nozzles 36F in the sub-scanning direction X. The pointer 70 (or more specifically, the light emission hole 77) is disposed between the most upstream nozzle 35R and the most downstream nozzle 35F of each ink head 34 in the sub-scanning direction X and between the most upstream nozzle 36R and the most downstream nozzle 36F of each ink head 34 in the sub-scanning direction X. In the present preferred embodiment, the pointer 70 (or more specifically, the light emission hole 77) is disposed forward of the most upstream nozzles 35R and 36R and rearward of the most downstream nozzles 35F and 36F. The pointer 70 (or more specifically, the light emission hole 77) is preferably disposed downstream of an intermediate point Q located between the most upstream nozzle 35R and the most downstream nozzle 35F of each ink head 34 in the sub-scanning direction X and between the most upstream nozzle 36R and the most downstream nozzle 36F of each ink head 34 in the sub-scanning direction X. When at least one of the first to third ink heads 34A to 34C is deviated in the sub-scanning direction X (i.e., when the first to third ink heads 34A to 34C are disposed in a staggered arrangement), the pointer 70 (or more specifically, the light emission hole 77) is preferably disposed in the above-described manner with respect to the most downstream ink head 34.

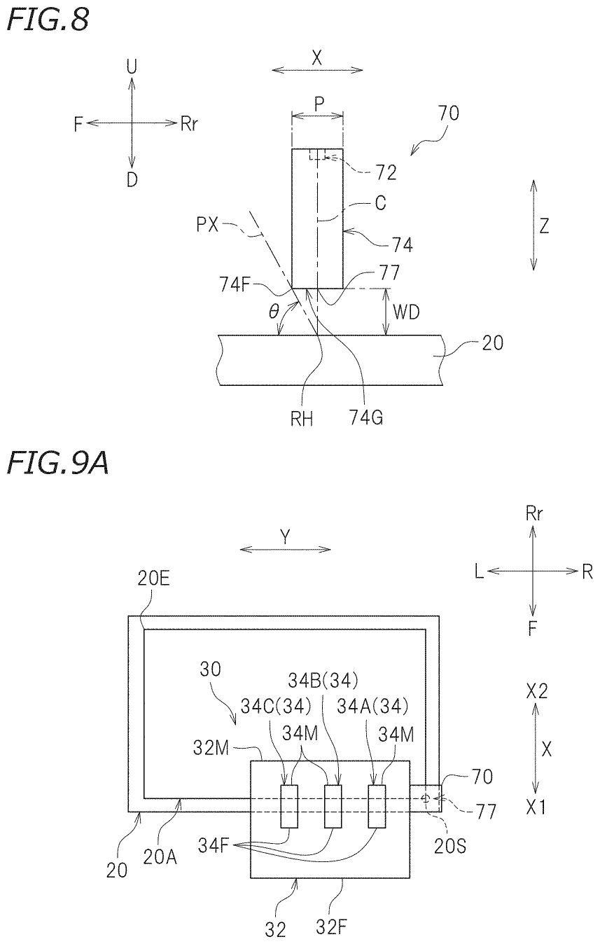

As illustrated in FIG. 8, the case 74 of the pointer 70 includes a lower surface 74G provided with the light emission hole 77. The lower surface 74G of the case 74 and the table 20 have a distance WD therebetween in the up-down direction Z. The case 74 of the pointer 70 has a length P in the sub-scanning direction X. The case 74 of the pointer 70 and the table 20 are disposed such that WD≥P/2. The lower surface 74G of the case 74 includes a front end 74F. The direct light R1 (see FIG. 7) emitted through the light emission hole 77 of the pointer 70 is applied to a point RH on the table 20 (or the upper surface of the recording medium 5). A straight line PX connects the front end 74F with the point RH. In a side view, an angle θ of 45 degrees or more is formed between the straight line PX and the table 20. The center of the light emission hole 77 is spaced away from the front end 74F of the lower surface 74G of the case 74 by P/2. In other words, the central axis C of the LED device 72 is spaced away from the front end 74F of the lower surface 74G of the case 74 by P/2.

The following description discusses a print range setting operation. As illustrated in FIG. 9A, a rectangular print region 20A is defined on the table 20. The recording medium 5 placed on the table 20 undergoes printing in the print region 20A. The print region 20A is provided with the print start point 20S and the print end point 20E. The print start point 20S is located on the right front end of the print region 20A. The print end point 20E is located on the left rear end of the print region 20A. In order for the printer 10 to recognize the print region 20A, the print range setting operation first involves moving the table 20 in the direction X2 (which is indicated by the arrow X2 in FIG. 9A) and moving the head carriage 32 rightward. The pointer 70 is thus located over the print start point 20S on the print region 20A, so that the pointer 70 applies direct light to the print start point 20S. The printer 10 stores information indicating that a position where the direct light overlaps with the print start point 20S is a print start position. The print range setting operation then involves moving the table 20 in the direction X1 (which is indicated by the arrow X1 in FIG. 9B) and moving the head carriage 32 leftward. The pointer 70 is thus located over the print end point 20E on the print region 20A, so that the pointer 70 applies direct light to the print end point 20E. The printer 10 stores information indicating that a position where the direct light overlaps with the print end point 20E is a print end position. This finishes the print range setting operation that involves using the pointer 70.

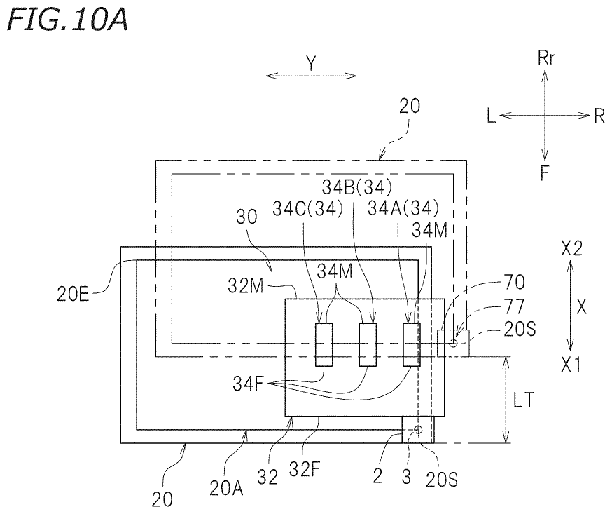

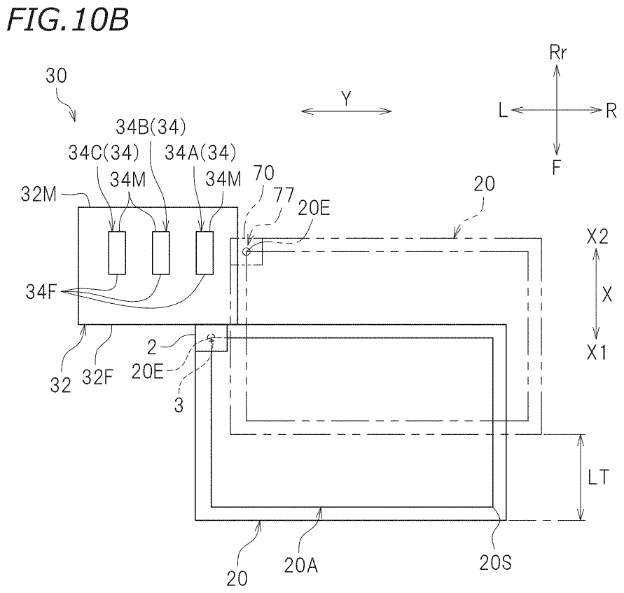

The following description discusses problems with a conventional pointer 2 on the assumption that the printer 10 includes the conventional pointer 2 instead of the pointer 70. The conventional pointer 2 applies direct light with poor visibility. Thus, the pointer 2 needs to be disposed as close as possible to an operator (i.e., downstream of the downstream end 32F of the head carriage 32) as illustrated in FIG. 10A. In order for the pointer 2 to apply direct light from a light application hole 3 to the print start point 20S, the table 20 used in conjunction with the pointer 2 (i.e., the table 20 indicated by the solid lines in FIG. 10A) has to be located downstream of the table 20 used in conjunction with the pointer 70 (i.e., the table indicated by the chain double-dashed lines in FIG. 10A). Suppose that the pointer 2 is disposed downstream of the downstream end 32F of the head carriage 32 as illustrated in FIG. 10A. In this case, the table 20 needs to be moved further to the downstream side in the sub-scanning direction X by a distance LT than when the pointer 70 is disposed upstream of the downstream end 34F of each ink head 34. In order for the pointer 2 to apply direct light from the light application hole 3 to the print end point 20E, the table 20 used in conjunction with the pointer 2 (i.e., the table 20 indicated by the solid lines in FIG. 10B) has to be located downstream of the table 20 used in conjunction with the pointer 70 (i.e., the table 20 indicated by the chain double-dashed lines in FIG. 10B). In other words, the table 20 needs to be moved further to the downstream side in the sub-scanning direction X by the distance LT. Accordingly, the use of the conventional pointer 2 increases the size of the first conveyor 21 (or more specifically, the lengths of the right slide rail 22R and the left slide rail in the sub-scanning direction X). In contrast, the pointer 70 of the printer 10 according to the present preferred embodiment applies direct light with good visibility. This enables the pointer 70 to be disposed upstream of the downstream end 32F of the head carriage 32, so that the printer 10 will not increase in overall size. The chain double-dashed lines in FIG. 10A indicate the locations of the table 20 and the pointer 70 when the pointer 70 according to the present preferred embodiment applies the direct light to the print start point 20S. The chain double-dashed lines in FIG. 10B indicate the locations of the table 20 and the pointer 70 when the pointer 70 according to the present preferred embodiment applies the direct light to the print end point 20E. In the examples illustrated in FIGS. 9A, 9B, 10A, and 10B, the case 31 of the ink head unit 30 is not illustrated.

As described above, the pointer 70 according to the present preferred embodiment includes the light passage hole 85 and the light emission hole 77 disposed on the central axis C of the LED device 72. The light from the LED device 72 includes light that passes through the central axis C. This light is relatively high in intensity. The high intensity light will be direct light that passes through the light passage hole 85 and the light emission hole 77 and is then applied to the external space. The direct light thus has high intensity, making the outline of the direct light clearer. The light from the LED device 72 needs to pass through the partition 80 before being emitted from the light emission hole 77 to the external space. Light from an LED device (i.e., a light source) of a commonly used pointer includes light applied in a direction deviated from the central axis of the LED device. This light is reflected inside a case of the pointer, resulting in an increase in spot diameter. The pointer 70 according to the present preferred embodiment, however, includes the partition 80 that changes the direction of most of light reflected inside the case 74. Most of the light reflected inside the case 74 is thus unable to pass through the light passage hole 85 of the partition 80, while a portion of the reflected light passes through the light passage hole 85. Accordingly, providing the partition 80 in the case 74 significantly reduces the amount of reflected light applied to the outside of the case 74. If the reflected light is applied to an area around direct light applied to the recording medium 5 or the table 20 on which the recording medium 5 is placed, the outline of the direct light would not be unclear. This makes it possible to clearly recognize the outline of the direct light.

Consequently, if the distance between the pointer 70 and a surface to which the direct light is to be applied (e.g., the upper surface of the recording medium 5 or the upper surface of the table 20) changes, the pointer 70 would be able to keep a spot diameter unchanged unlike a conventional pointer including no partition 80. A surface to which the direct light is to be applied (e.g., the upper surface of the recording medium 5 or the upper surface of the table 20) will hereinafter be referred to as a “target surface”.

The pointer 70 according to the present preferred embodiment includes the partition 80 protruded such that the partition 80 extends from the inner wall of the case 74 toward the central axis C of the LED device 72 in a direction perpendicular or substantially perpendicular to the central axis C of the LED device 72. The light passage hole 85 is defined by the extremity 83 of the partition 80. Thus, providing the partition 80 integral with the case 74 makes it possible to easily define the light passage hole 85 that reduces the amount of reflected light from the light emission hole 77.

The pointer 70 according to the present preferred embodiment includes the partition 80 located at the intermediate position M1 between the LED device 72 and the light emission hole 77. This further reduces the amount of reflected light that passes through the light passage hole 85. Alternatively, the partition 80 may be located closer to the LED device 72 than the intermediate position M1 between the LED device 72 and the light emission hole 77. This more effectively reduces the amount of reflected light that passes through the light passage hole 85.

The pointer 70 according to the present preferred embodiment includes the light passage hole 85 larger than the light emission hole 77. The direct light that passes through the light passage hole 85 will thus not be blocked by the partition 80. Consequently, the direct light guided into the light emission hole 77 will not be weakened.

The printer 10 according to the present preferred embodiment is configured such that WD≥P/2, where WD represents the distance between the table 20 and the lower surface 74G of the pointer 70 provided with the light emission hole 77 in the up-down direction Z, and P represents the length of the case 74 of the pointer 70 in the sub-scanning direction X. Usually, an increase in the distance between a pointer (which includes an LED device serving as a light source) and a target surface results in an increase in spot diameter, making it difficult to recognize the center of the spot diameter. This requires reducing the distance between the pointer and the target surface in setting base points, such as a print start position and a print end position. The pointer 70 according to the present preferred embodiment, however, includes the partition 80 provided in the case 74 so as to significantly reduce the amount of reflected light applied to the outside of the case 74. Thus, if the reflected light is applied to an area around the direct light applied to the recording medium 5 or the table 20 on which the recording medium 5 is placed, the outline of the direct light would not be unclear. This makes it possible to clearly recognize the outline of the direct light. Consequently, if the distance between the pointer 70 and the target surface changes, the pointer would be able to keep a spot diameter unchanged unlike a conventional pointer including no partition 80. In other words, the present preferred embodiment makes it unnecessary to reduce the distance between the pointer 70 and the target surface, and allows some distance between the pointer 70 and the target surface. The distance between the pointer 70 and the target surface is set such that WD≥P/2. Thus, although the pointer 70 includes the LED device 72 serving as a light source, the direct light from the pointer 70 to the table 20 or the recording medium 5 will not be blocked by the case 74 of the pointer 70 when the operator makes a check at an angle of elevation of about 45 degrees or more relative to the table 20. In other words, the present preferred embodiment increases the visibility of the direct light. Because the pointer 70 according to the present preferred embodiment (which includes the LED device 72) reduces the amount of reflected light from the light emission hole 77, the outline of the direct light would be clear if the distance between the pointer 70 and the target surface is set such that WD≥P/2.

As illustrated in FIG. 4, the printer 10 according to the present preferred embodiment includes the pointer 70 disposed to overlap with the head carriage 32 when viewed in the main scanning direction Y. More specifically, the pointer 70 is disposed upstream of the downstream end 32F of the head carriage 32 in the sub-scanning direction X and downstream of an upstream end 32M of the head carriage 32 in the sub-scanning direction X. Thus, in defining the print start point 20S and the print end point 20E using the pointer 70, a distance by which the table 20 is to be moved in the sub-scanning direction X is shorter than when the pointer 70 is deviated from the head carriage 32 as viewed in the main scanning direction Y (e.g., when the pointer 70 is disposed on the front surface of the head carriage 32 or forward of the downstream end 32F of the head carriage 32). If the pointer 70 is disposed on the front surface of the head carriage 32, defining the print end point 20E using the pointer 70 unfortunately requires moving the table 20 farther downstream in the sub-scanning direction X from the position of the table 20 at the end of printing. The size of the body case 12 in which the table 20 is housed will thus increase in accordance with the distance by which the table 20 is to be moved downstream. In the present preferred embodiment, however, the pointer 70 is disposed to overlap with the head carriage 32 as viewed in the main scanning direction Y. Accordingly, the distance by which the table 20 is to be moved in the sub-scanning direction X is shorter than when the pointer 70 is disposed on the front surface of the head carriage 32. Consequently, the body case 12 in which the table 20 is housed is compact in size in the sub-scanning direction X.

As illustrated in FIG. 4, the printer 10 according to the present preferred embodiment includes the pointer 70 disposed to overlap with the ink heads 34 when viewed in the main scanning direction Y. More specifically, the pointer 70 is disposed upstream of the downstream end 34F of each ink head 34 in the sub-scanning direction X and downstream of an upstream end 34M of each ink head 34 in the sub-scanning direction X. Because the pointer 70 is disposed to overlap with the ink heads 34 as viewed in the main scanning direction Y in the present preferred embodiment, the distance by which the table 20 is to be moved in the sub-scanning direction X is shorter than when the pointer 70 does not overlap with the ink heads 34 as viewed in the main scanning direction Y. The present preferred embodiment thus reduces the distance by which the table 20 is to be moved in the sub-scanning direction X in defining the print start point 20S and the print end point 20E using the pointer 70. Consequently, the body case 12 in which the table 20 is housed is compact in size in the sub-scanning direction X.

The printer 10 according to the present preferred embodiment includes the pointer 70 disposed between the most upstream nozzle 35R and the most downstream nozzle 35F (which are included in the first nozzles 35 of each ink head 34) in the sub-scanning direction X and between the most upstream nozzle 36R and the most downstream nozzle 36F (which are included in the second nozzles 36 of each ink head 34) in the sub-scanning direction X. This makes it possible to bring the pointer 70 over the center of printing so as to enable positioning of the pointer 70 within the print region 20A. Thus, the positioning of the pointer 70 in the direction in which the first and second nozzles 35 and 36 are arranged (i.e., the sub-scanning direction X in the present preferred embodiment) does not require moving the table 20 in the sub-scanning direction X. Consequently, the present preferred embodiment facilitates the positioning of the pointer 70 relative to a print result.

The printer 10 according to the present preferred embodiment includes the pointer 70 disposed downstream of the intermediate point Q between the most upstream nozzle 35R and the most downstream nozzle 35F of each ink head 34 in the sub-scanning direction X and between the most upstream nozzle 36R and the most downstream nozzle 36F of each ink head 34 in the sub-scanning direction X. This enables the pointer 70 to be brought closer to the operator. Consequently, the present preferred embodiment increases the visibility of the outline of the direct light from the pointer 70.

The printer 10 according to the present preferred embodiment includes the pointer 70 attached to the right side surface 32R of the head carriage 32. The right side surface 32R is located adjacent to the operation panel 19 in the main scanning direction Y. This enables, for example, the operator to easily visually check the direct light from the pointer 70 while operating the operation panel 19.

The printer 10 according to the present preferred embodiment includes the first conveyor 21 that is able to move the table 20 in the sub-scanning direction X. Suppose that the pointer 70 applies direct light to the positioning reference points (e.g., the print start point 20S and the print end point 20E) on the recording medium 5 or the table 20 so as to define the print range of the printer 10. In this case, the table 20 has to be moved to a position downstream of the downstream end 32F of the head carriage 32 in the sub-scanning direction X when the pointer 70 is disposed downstream of the downstream end 32F of the head carriage 32 in the sub-scanning direction X, but the table 20 does not have to be moved to a position downstream of the downstream end 32F of the head carriage 32 in the sub-scanning direction X when the pointer 70 is disposed upstream of the downstream end 32F of the head carriage 32 in the sub-scanning direction X. The present preferred embodiment thus further reduces the space necessary for movement of the table 20, resulting in a reduction in overall size of the printer 10.

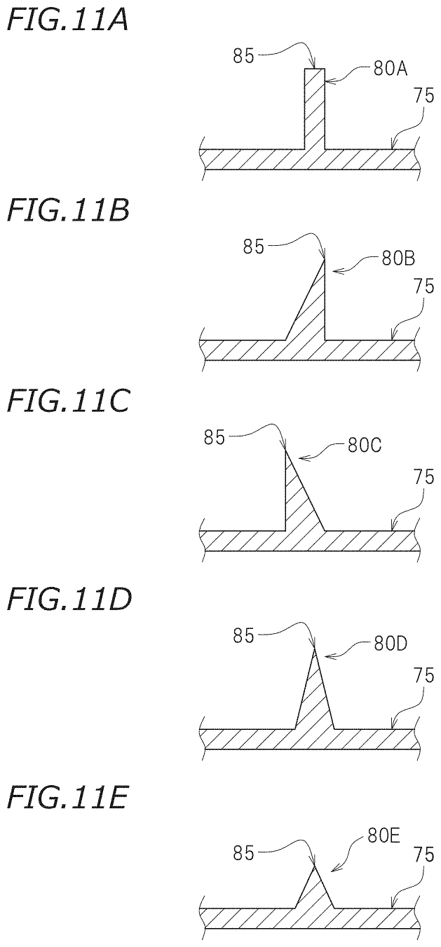

The shape of the partition 80 is not limited to the shape illustrated in FIG. 7. In one example, the pointer 70 may include a partition 80A having an oblong shape when viewed in cross section as illustrated in FIG. 11A. In another example, the pointer 70 may include a partition 80B having a right-angled triangular shape when viewed in cross section as illustrated in FIG. 11B. In still another example, the pointer 70 may include a partition 80C having a right-angled triangular shape when viewed in cross section as illustrated in FIG. 11C. In yet another example, the pointer 70 may include a partition 80D having an isosceles triangular shape when viewed in cross section as illustrated in FIG. 11D. In still yet another example, the pointer 70 may include a partition 80E having an equilateral triangular shape when viewed in cross section as illustrated in FIG. 11E. Each of FIGS. 11A to 11E is a partial cross-sectional view of the pointer 70 taken in the up-down direction Z.

The inner wall of the second chamber 74B may be subjected to a surface treatment so as to attenuate the light from the LED device 72. In one example, the inner wall of the second chamber 74B is provided with projections and depressions. In another example, the color of the inner wall of the second chamber 74B is black. Thus, the inner wall of the second chamber 74B absorbs or diffuses reflected light (which is included in light having passed through the light passage hole 85 and travels to the inner wall of the second chamber 74B) so as to attenuate the reflected light. Consequently, the present preferred embodiment prevents the reflected light (which is included in light having passed through the light passage hole 85 and travels to the inner wall of the second chamber 74B) from being emitted from the light emission hole 77 to the outside of the case 74.

### Second Preferred Embodiment

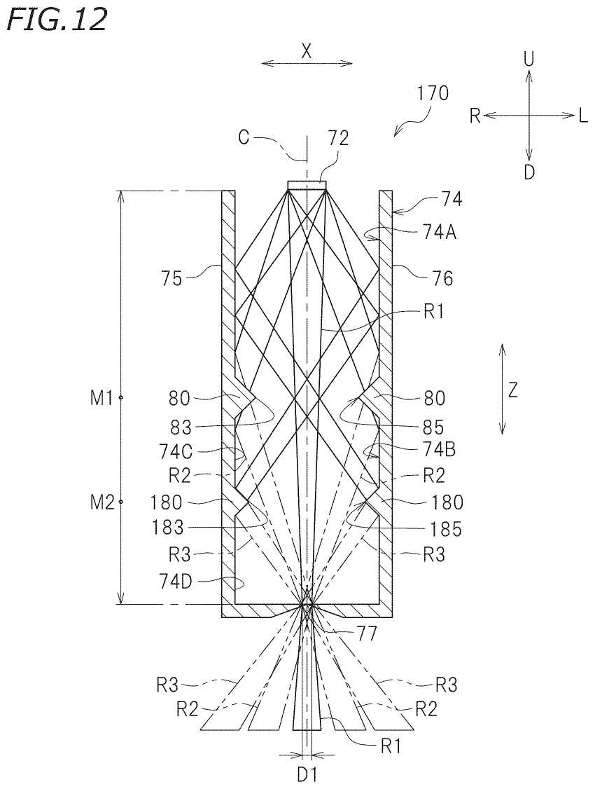

FIG. 12 is a cross-sectional view of a pointer 170 according to a second preferred embodiment of the present invention, schematically illustrating a structure of the pointer 170. The pointer 170 further includes an additional partition 180. The additional partition 180 is provided in the case 74. The additional partition 180 is disposed in the second chamber 74B. The additional partition 180 is provided between the partition 80 and the light emission hole 77. The additional partition 180 is provided below the partition 80. The additional partition 180 is provided above the light emission hole 77. The additional partition 180 is located closer to the light emission hole 77 than the intermediate position M1 between the LED device 72 and the light emission hole 77. The additional partition 180 is located at an intermediate position M2 between the partition 80 and the light emission hole 77. The additional partition 180 divides the second chamber 74B into a third chamber 74C located adjacent to the partition 80, and a fourth chamber 74D located adjacent to the light emission hole 77. The third chamber 74C is in communication with the light passage hole 85. The fourth chamber 74D is in communication with the light emission hole 77. The fourth chamber 74D is located below the third chamber 74C. The additional partition 180 is provided with an additional light passage hole 185. Light that has passed through the light passage hole 85 then passes through the additional light passage hole 185. The additional light passage hole 185 is larger than the light emission hole 77. The additional light passage hole 185 is larger than the light passage hole 85. The additional light passage hole 185 is disposed on the central axis C of the LED device 72. The additional partition 180 is made of, for example, aluminum.

The additional partition 180 according to the present preferred embodiment has a protruding shape. The additional partition 180 extends toward the central axis C of the LED device 72 in a direction perpendicular or substantially perpendicular to the central axis C of the LED device 72. The additional partition 180 protrudes toward the central axis C from the right wall 75A, the front wall 75B, and the rear wall 75C of the first case 75 and from the left wall 76A, the front wall 76B, and the rear wall 76C of the second case 76. The additional partition 180 has an equilateral triangular shape in vertical cross section. The additional light passage hole 185 is defined by an extremity 183 of the additional partition 180. In the present preferred embodiment, the additional light passage hole 185 has a rectangular shape. Alternatively, the additional light passage hole 185 may have a circular shape. In the example illustrated in FIG. 12, the partition 80 has an equilateral triangular shape in vertical cross section (e.g., the shape illustrated in FIG. 11E).

The light from the LED device 72 includes two-time reflected light R3. The two-time reflected light R3 is reflected twice inside the case 74. The additional partition 180 prevents the two-time reflected light R3 from being emitted from the light emission hole 77 to the outside of the case 74. Because the two-time reflected light R3 is the second brightest reflected light, the additional partition 180 precludes the two-time reflected light R3 from being emitted from the light emission hole 77 to the outside of the case 74. This prevents the two-time reflected light R3 from making the outline of the direct light R1 unclear. Consequently, the pointer 170 including the partition 80 and the additional partition 180 prevents not only the one-time reflected light R2 but also the two-time reflected light R3 from making the outline of the direct light R1 unclear.

The pointer 170 according to the present preferred embodiment includes the additional partition 180 provided in the case 74. The additional partition 180 is disposed between the partition 80 and the light emission hole 77. The additional partition 180 is provided with the additional light passage hole 185. The light that has passed through the light passage hole 85 then passes through the additional light passage hole 185. The additional light passage hole 185 is disposed on the central axis C of the LED device 72. The light from the LED device 72 includes light that passes through the central axis C. This light will pass through the additional light passage hole 185 without being blocked by the additional partition 180. Most of reflected light that has passed through the light passage hole 85 is unable to pass through the additional light passage hole 185 of the additional partition 180, while only a portion of the reflected light passes through the additional light passage hole 185. Thus, providing the additional partition 180 in the case 74 makes it possible to further reduce the amount of reflected light applied to the outside of the case 74. Consequently, if the reflected light is applied to an area around the direct light applied to the recording medium 5 or the table 20 on which the recording medium 5 is placed, the outline of the direct light would not be unclear. This makes it possible to more clearly recognize the outline of the direct light.

The pointer 170 according to the present preferred embodiment includes the additional partition 180 disposed closer to the light emission hole 77 than the partition 80. The additional partition 180 protrudes such that the additional partition 180 extends from the inner wall of the case 74 toward the central axis C of the LED device 72 in a direction perpendicular or substantially perpendicular to the central axis C of the LED device 72. The additional light passage hole 185 is defined by the extremity 183 of the additional partition 180. Thus, providing the additional partition 180 integral with the case 74 makes it possible to easily define the additional light passage hole 185 that reduces the amount of reflected light from the light emission hole 77.

The pointer 170 according to the present preferred embodiment includes the additional partition 180 located closer to the light emission hole 77 than the intermediate position M1 between the LED device 72 and the light emission hole 77. This further reduces the amount of reflected light that passes through the additional light passage hole 185.

The pointer 170 according to the present preferred embodiment includes the additional light passage hole 185 larger than the light passage hole 85. The direct light that passes through the additional light passage hole 185 will thus not be blocked by the additional partition 180. Consequently, the direct light guided into the light emission hole 77 will not be weakened.

### Third Preferred Embodiment

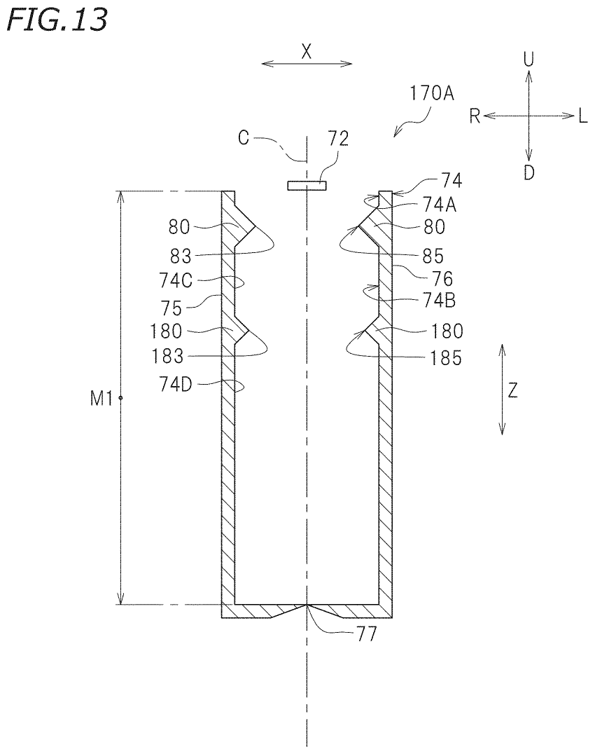

FIG. 13 is a cross-sectional view of a pointer 170A according to a third preferred embodiment of the present invention, schematically illustrating a structure of the pointer 170A. The pointer 170A further includes an additional partition 180. The partition 80 is located closer to the LED device 72 than the intermediate position M1 between the LED device 72 and the light emission hole 77. The additional partition 180 is located closer to the light emission hole 77 than the partition 80. The additional partition 180 is located closer to the LED device 72 than the intermediate position M1.

### Fourth Preferred Embodiment

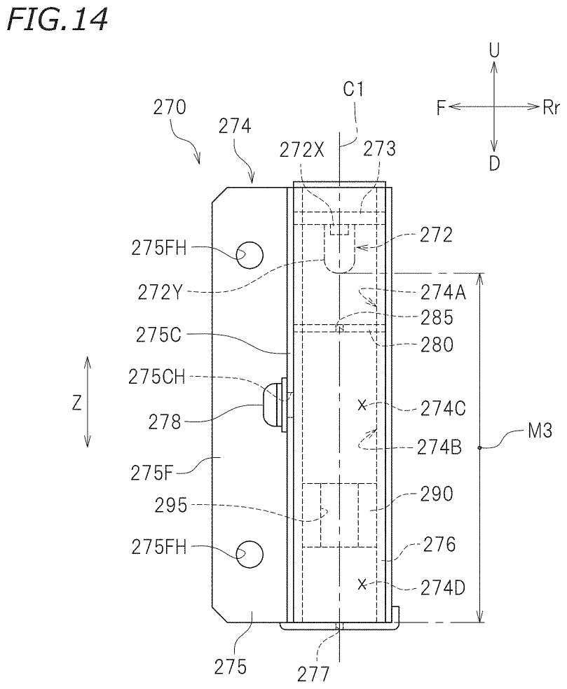

FIG. 14 is a side view of a pointer 270 according to a fourth preferred embodiment of the present invention. As illustrated in FIG. 14, the pointer 270 includes an LED device 272, a case 274, a plate 280, and a porous member 290. The plate 280 is an example of a first partition. The porous member 290 is an example of a second partition.

As illustrated in FIG. 14, the LED device 272 is housed in the case 274. The LED device 272 according to the present preferred embodiment includes an LED chip 272X and a lens 272Y covering the LED chip 272X. The LED device 272 is disposed in a first chamber 274A (which will be described below). The LED device 272 is attached to an LED substrate 273. The LED device 272 attached to the LED substrate 273 is further attached to a second case 276 (which will be described below) of the case 274. The LED device 272 applies, for example, red light. In the present preferred embodiment, the LED device 272 is housed in the case 274 such that the LED device 272 applies light downward.

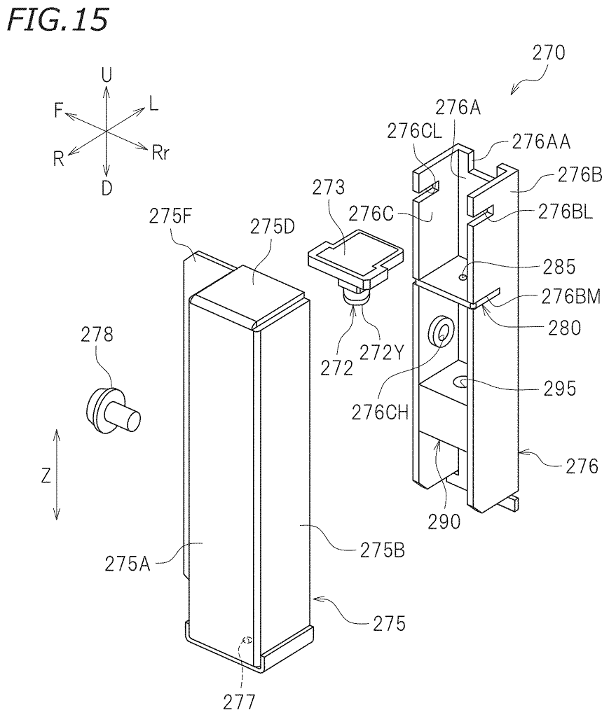

As illustrated in FIG. 14, the case 274 has a cuboid shape. The case 274 extends in the up-down direction Z. As illustrated in FIG. 15, the case 274 includes a first case 275 and the second case 276. The first case 275 and the second case 276 are each made of, for example, aluminum. Alternatively, the first case 275 and the second case 276 may each be made of a metal material other than aluminum or a resin material.

As illustrated in FIG. 15, the first case 275 includes a bottom wall 275A, a rear wall 275B, a front wall 275C (see FIG. 14), an upper wall 275D, a lower wall 275E (see FIG. 17), and an extended wall 275F. The bottom wall 275A extends in the up-down direction Z. The rear wall 275B extends leftward from the rear end of the bottom wall 275A. The front wall 275C extends leftward from the front end of the bottom wall 275A. The front wall 275C faces the rear wall 275B. The front wall 275C is provided with a threaded hole 275CH (see FIG. 14). A screw 278 is inserted into the threaded hole 275CH so as to secure the first case 275 and the second case 276 to each other. The upper wall 275D extends leftward from the upper end of the bottom wall 275A. The lower wall 275E extends leftward from the lower end of the bottom wall 275A. The lower wall 275E faces the upper wall 275D. The lower wall 275E is provided with a light emission hole 277 (see also FIG. 17) through which the light from the LED device 272 is emitted to the external space (i.e., the outside of the case 274 in the present preferred embodiment). The light emission hole 277 is disposed on a central axis C1 of the LED device 272. An opening 275H (see FIG. 17) is defined by the bottom wall 275A, the rear wall 275B, the front wall 275C, the upper wall 275D, and the lower wall 275E. The second case 276 is inserted into the opening 275H. The extended wall 275F extends forward from the left end of the front wall 275C. The extended wall 275F is provided with through holes 275FH (see FIG. 14). Screws (not illustrated), for example, are inserted into the through holes 275FH so as to secure the first and second cases 275 and 276 to the case 31 (see FIG. 2) of the ink head unit 30.

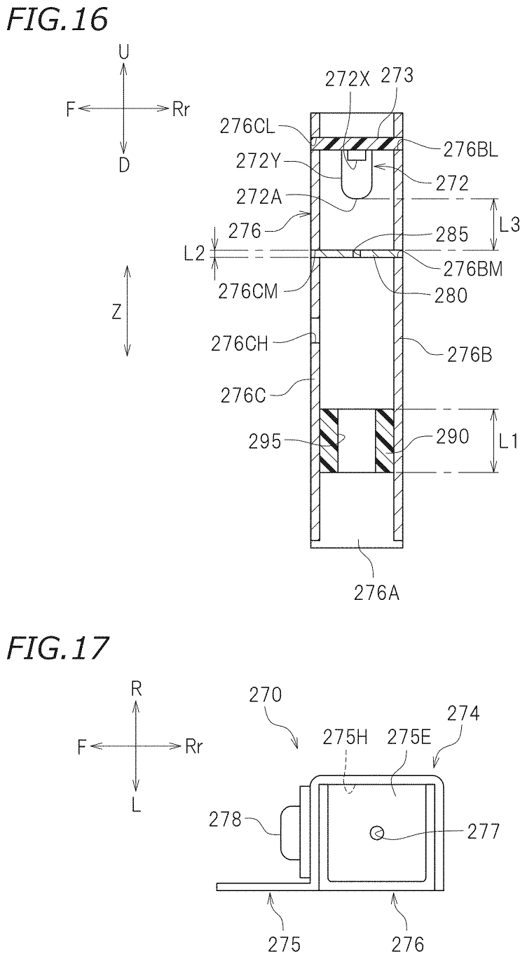

As illustrated in FIG. 15, the second case 276 includes a bottom wall 276A, a rear wall 276B, and a front wall 276C. The bottom wall 276A extends in the up-down direction Z. With the first case 275 and the second case 276 secured to each other, the bottom wall 276A of the second case 276 faces the bottom wall 275A of the first case 275. The bottom wall 276A is provided with a cut-out 276AA that allows passage of wiring (not illustrated) connected to the LED substrate 273. The rear wall 276B extends rightward from the rear end of the bottom wall 276A. With the first case 275 and the second case 276 secured to each other, the rear wall 276B of the second case 276 overlaps with the rear wall 275B of the first case 275. The rear wall 276B is provided with a first engagement groove 276BL in engagement with the LED substrate 273. The first engagement groove 276BL is recessed from the right end of the rear wall 276B toward the left end of the rear wall 276B. The rear wall 276B is provided with a second engagement groove 276BM in engagement with the plate 280. The second engagement groove 276BM is recessed from the right end of the rear wall 276B toward the left end of the rear wall 276B. The second engagement groove 276BM is provided below the first engagement groove 276BL. The front wall 276C extends rightward from the front end of the bottom wall 276A. The front wall 276C faces the rear wall 276B. With the first case 275 and the second case 276 secured to each other, the front wall 276C of the second case 276 overlaps with the front wall 275C of the first case 275. The front wall 276C is provided with a first engagement groove 276CL in engagement with the LED substrate 273. The first engagement groove 276CL is recessed from the right end of the front wall 276C toward the left end of the front wall 276C. The front wall 276C is provided with a second engagement groove 276CM (see FIG. 16) in engagement with the plate 280. The second engagement groove 276CM is recessed from the right end of the front wall 276C toward the left end of the front wall 276C. The second engagement groove 276CM is provided below the first engagement groove 276CL. The front wall 276C is provided with a threaded hole 276CH. The screw 278 is inserted into the threaded hole 276CH so as to secure the first case 275 and the second case 276 to each other. With the second case 276 inserted into the opening 275H of the first case 275, the threaded hole 276CH of the second case 276 overlaps with the threaded hole 275CH of the first case 275. The threaded hole 276CH is provided below the second engagement groove 276CM.

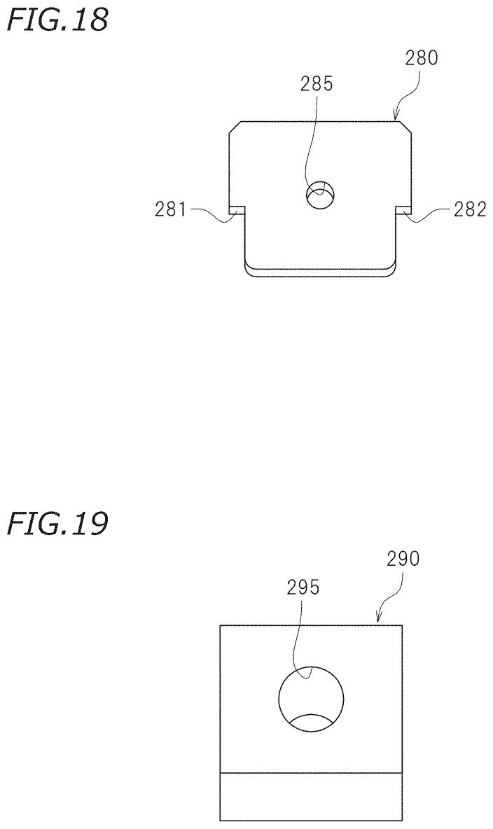

As illustrated in FIG. 14, the plate 280 is disposed in the case 274. As illustrated in FIG. 16, the plate 280 is in engagement with the second engagement grooves 276BM and 276CM of the second case 276. As illustrated in FIG. 14, the plate 280 is disposed between the LED device 272 and the light emission hole 277. The plate 280 is disposed below the LED device 272. The plate 280 is disposed above the light emission hole 277. The plate 280 is disposed above the porous member 290. The plate 280 is disposed closer to the LED device 272 than an intermediate position M3 between the LED device 272 and the light emission hole 277. The plate 280 is disposed above the intermediate position M3. The plate 280 divides the case 274 into the first chamber 274A and a second chamber 274B. The LED device 272 is housed in the first chamber 274A. The second chamber 274B is in communication with the light emission hole 277. As illustrated in FIG. 18, the plate 280 includes a first step 281 and a second step 282. The first step 281 is in engagement with the second engagement groove 276BM. The second step 282 is in engagement with the second engagement groove 276CM. The plate 280 is provided with a first light passage hole 285. The light from the LED device 272 passes through the first light passage hole 285. The first light passage hole 285 is larger in diameter than the light emission hole 277. As illustrated in FIG. 14, the first light passage hole 285 is disposed on the central axis C1 of the LED device 272. The plate 280 is made of, for example, aluminum.

As illustrated in FIG. 14, the porous member 290 is disposed in the case 274. Specifically, the porous member 290 is disposed in the second chamber 274B. As illustrated in FIG. 16, the porous member 290 is secured to the bottom wall 276A, the rear wall 276B, and the front wall 276C of the second case 276. The porous member 290 is secured to the second case 276 with, for example, an adhesive. As illustrated in FIG. 14, the porous member 290 is disposed between the plate 280 and the light emission hole 277. The porous member 290 is disposed below the plate 280. The porous member 290 is disposed above the light emission hole 277. The porous member 290 is located closer to the light emission hole 277 than the intermediate position M3 between the LED device 272 and the light emission hole 277. The porous member 290 is located below the intermediate position M3. The porous member 290 divides the second chamber 274B into a third chamber 274C and a fourth chamber 274D. The third chamber 274C is located adjacent to the plate 280. The fourth chamber 274D is located adjacent to the light emission hole 277. The third chamber 274C is in communication with the first light passage hole 285. The fourth chamber 274D is in communication with the light emission hole 277. As illustrated in FIG. 19, the porous member 290 is provided with a second light passage hole 295. The light that has passed through the first light passage hole 285 of the plate 280 then passes through the second light passage hole 295. The second light passage hole 295 is larger in diameter than the light emission hole 277. The second light passage hole 295 is larger in diameter than the first light passage hole 285. As illustrated in FIG. 14, the second light passage hole 295 is disposed on the central axis C1 of the LED device 272. As illustrated in FIG. 16, the porous member 290 is thicker than the plate 280. Specifically, a length (or thickness) L1 of the porous member 290 measured in the up-down direction Z is longer than a length (or thickness) L2 of the plate 280 measured in the up-down direction Z. The thickness of the porous member 290 is greater than a distance L3 between the plate 280 and a lower end (or extremity) 272A of the LED device 272 facing the plate 280. Specifically, the length L1 of the porous member 290 in the up-down direction Z is longer than the distance L3 between the plate 280 and the lower end 272A of the LED device 272. The porous member 290 is made of a porous material (such as a sponge). The porous member 290 has a color that absorbs the light from the LED device 272. In one example, the color of the porous member 290 is black.

The pointer 270 according to the present preferred embodiment includes the porous member 290 having the thickness L1 greater than the distance L3 between the plate 280 and the lower end 272A of the LED device 272 facing the plate 280. This further reduces the amount of reflected light that passes through the second light passage hole 295.

The pointer 270 according to the present preferred embodiment includes the porous member 290 having the thickness L1 larger than the thickness L2 of the plate 280. If the thickness L1 of the porous member 290 is small, the reflected light may pass through the second light passage hole 295. Making the thickness L1 of the porous member 290 larger than the thickness L2 of the plate 280, however, enables the porous member 290 to absorb the reflected light passing through the second light passage hole 295. This further reduces the amount of reflected light that passes through the second light passage hole 295.

The pointer 270 according to the present preferred embodiment includes the porous member 290 having a color that absorbs the light from the LED device 272. The porous member 290 will thus absorb the reflected light emitted to the porous member 290. This further reduces the amount of reflected light that passes through the second light passage hole 295.

The pointer 270 according to the present preferred embodiment includes the porous member 290 located closer to the light emission hole 277 than the intermediate position M3. This reduces the amount of reflected light that passes through the second light passage hole 295.

### Fifth Preferred Embodiment

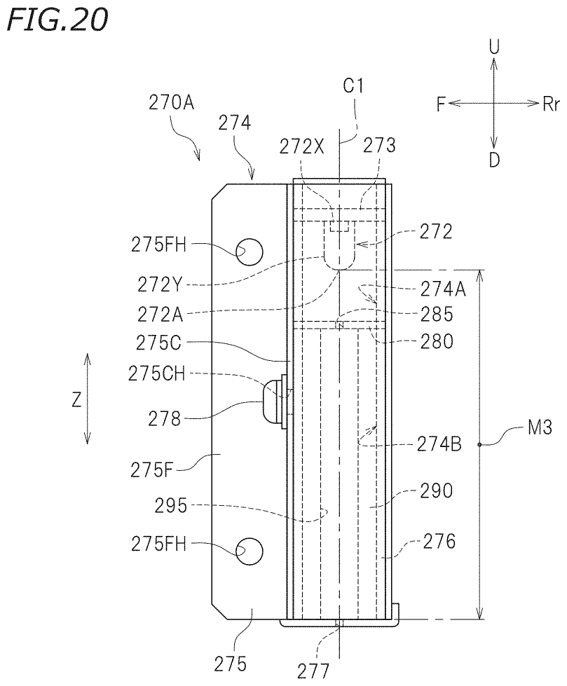

FIG. 20 is a side view of a pointer 270A according to a fifth preferred embodiment of the present invention. As illustrated in FIG. 20, the pointer 270A includes an LED device 272, a case 274, a plate 280, and a porous member 290.

As illustrated in FIG. 20, the porous member 290 is disposed in the case 274. Specifically, the porous member 290 is disposed in a second chamber 274B. The porous member 290 is disposed such that the porous member 290 extends across an entirety of the second chamber 274B along a central axis C1 of the LED device 272 (i.e., in the up-down direction Z in the present preferred embodiment). The porous member 290 is provided with a second light passage hole 295. Light that has passed through a first light passage hole 285 of the plate 280 then passes through the second light passage hole 295. The second light passage hole 295 is disposed on the central axis C1 of the LED device 272. In the present preferred embodiment, the porous member 290 extends across the entirety of the second chamber 274B. Thus, reflected light that has passed through the first light passage hole 285 does not reach the inner wall of the case 274, so that most of the reflected light is absorbed by the porous member 290. Accordingly, providing the porous member 290 extending across the entirety of the second chamber 274B in the up-down direction Z further reduces the amount of reflected light applied to the outside of the case 274.

The pointer 270A according to the present preferred embodiment includes the porous member 290 extending across the entirety of the second chamber 274B. Thus, the reflected light that has passed through the first light passage hole 285 does not reach the inner wall of the case 274, so that most of the reflected light is absorbed by the porous member 290. Accordingly, providing the porous member 290 extending across the entirety of the second chamber 274B in the up-down direction Z further reduces the amount of reflected light applied to the outside of the case 274.

The pointer 270A according to the present preferred embodiment includes the porous member 290 having a thickness greater than a distance between the plate 280 and a lower end 272A of the LED device 272 facing the plate 280. This further reduces the amount of reflected light that passes through the second light passage hole 295.

Although the preferred embodiments of the present invention have been described thus far, the preferred embodiments described above are only illustrative. The present invention may be embodied in various other forms.

In the fifth preferred embodiment described above, the plate 280 and the porous member 290 are disposed between the LED device 272 and the light emission hole 277. Alternatively, at least one component similar to the plate 280 may be disposed between the plate 280 and the porous member 290 and/or between the porous member 290 and the light emission hole 277.

In each of the foregoing preferred embodiments, the table 20 is moved in the sub-scanning direction X relative to the ink heads 34. The table 20, however, does not necessarily have to be moved in this manner. In one example, the table 20 may be secured to the support base 15, and the ink heads 34 may be moved in the sub-scanning direction X relative to the table 20.

In each of the foregoing preferred embodiments, the table 20 is moved in the up-down direction Z relative to the ink heads 34. The table 20, however, does not necessarily have to be moved in this manner. In one example, the table 20 may be secured to the support base 15, and the ink heads 34 may be moved in the up-down direction Z relative to the table 20.

The techniques disclosed herein are usable for various types of printers. The techniques disclosed herein are usable not only for the printer 10 of a flatbed type illustrated in the foregoing preferred embodiments but also for the printer 10 of a “roll-to-roll” type in which the recording medium 5 in a rolled form, for example, is conveyed in the sub-scanning direction X.

In each of the foregoing preferred embodiments, the LED device 72 includes the single LED chip 72X, or the LED device 272 includes the single LED chip 272X. Alternatively, the LED devices 72 and 272 may each include any other number of LED chips. The LED devices 72 and 272 may each include two or more LED chips (e.g., a red LED chip, a green LED chip, and a blue LED chip). This makes it possible to select a suitable color for the direct light to be applied from the pointer 70, 170, 170A, 270, or 270A, such that the direct light applied to the recording medium 5 or the table 20 is easily recognizable. For example, suppose that the color of the recording medium 5 is red, and the color of the light emitted from the LED chip 72X of the LED device 72 or the LED chip 272X of the LED device 272 is red. In such a case, the outline of the direct light will be unclear on the recording medium 5, making it difficult to recognize the direct light. A solution to this problem involves changing the color of the direct light (which is to be applied from the pointer 70, 170, 170A, 270, or 270A) to white or blue such that the outline of the direct light will be clear on the recording medium 5. This enables the operator to easily recognize the direct light. In one example, the color of the recording medium 5 or the table 20 and the color of the direct light to be applied from the LED device 72 or 272 are preferably complementary to each other. In this case, when the color of the recording medium 5 is blue, the color of the direct light is preferably yellow. In another example, the color of the direct light to be applied from the LED device 72 or 272 is preferably reverse in brightness to the color of the recording medium 5 or the table 20. In this case, when the color of the recording medium 5 is black, the color of the direct light is preferably white. The printer 10 may include a controller that is able to change the color of the direct light to a color easily recognizable to the operator while actually applying the direct light from the pointer 70, 170, 170A, 270, or 270A to the recording medium 5 or the table 20. The LED devices 72 and 272 may each include a point light source LED chip. The color of light from the point light source LED chip is, for example, red.

In each of the foregoing preferred embodiments, the cases 74 and 274 each have a cuboid shape. The cases 74 and 274 may each have any other suitable shape. In one example, the cases 74 and 274 may each have a cylindrical shape.

Each of the foregoing preferred embodiments has been described on the assumption that a processing apparatus to which the present invention is applied is the printer 10 equipped with the pointer 70, 170, 170A, 270, or 270A. Preferred embodiments of the present invention, however, may be applied to any other processing apparatuses. Examples of processing apparatuses to which preferred embodiments of the present invention are applicable include: a cutter to cut an object into a desired shape; a stamping press to transfer foil to an object; a cutting apparatus to cut an object so as to machine the object into a desired shape; an embroidering apparatus to decorate an object using an embroidery thread and an embroidery needle; and a three-dimensional printing apparatus to form an object into a three-dimensional object having a desired shape.

The terms and expressions used herein are for description only and are not to be interpreted in a limited sense. These terms and expressions should be recognized as not excluding any equivalents to the elements shown and described herein and as allowing any modification encompassed in the scope of the claims. The present invention may be embodied in many various forms. This disclosure should be regarded as providing preferred embodiments of the principles of the present invention. These preferred embodiments are provided with the understanding that they are not intended to limit the present invention to the preferred embodiments described in the specification and/or shown in the drawings. The present invention is not limited to the preferred embodiments described herein. The present invention encompasses any of preferred embodiments including equivalent elements, modifications, deletions, combinations, improvements and/or alterations which can be recognized by a person of ordinary skill in the art based on the disclosure. The elements of each claim should be interpreted broadly based on the terms used in the claim, and should not be limited to any of the preferred embodiments described in this specification or used during the prosecution of the present application.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A pointer comprising:
an LED device;
a case housing the LED device and including a light emission hole through which light from the LED device is emitted to an external space; and
a first partition disposed in the case such that the first partition is located between the LED device and the light emission hole, the first partition dividing the case into a first chamber and a second chamber, the first chamber housing the LED device, the second chamber being in communication with the light emission hole; wherein
the first partition includes a first light passage hole through which the light from the LED device passes; and
the first light passage hole and the light emission hole are disposed on a central axis of the LED device.

2. The pointer according to claim 1, wherein
the first partition protrudes such that the first partition extends from an inner wall of the case toward the central axis of the LED device in a direction perpendicular or substantially perpendicular to the central axis of the LED device; and
the first light passage hole is defined by an extremity of the first partition.

3. The pointer according to claim 1, wherein the first partition is located at an intermediate position between the LED device and the light emission hole or closer to the LED device than the intermediate position.

4. The pointer according to claim 1, wherein the first light passage hole is larger than the light emission hole.

5. The pointer according to claim 1, further comprising a second partition located between the first partition and the light emission hole to divide the second chamber into a third chamber and a fourth chamber, the third chamber being located adjacent to the first partition, the fourth chamber being located adjacent to the light emission hole; wherein
the second partition includes a second light passage hole through which the light that has passed through the first light passage hole passes; and
the second light passage hole is disposed on the central axis of the LED device.

6. The pointer according to claim 5, wherein
the second partition protrudes such that the second partition extends from an inner wall of the case toward the central axis of the LED device in a direction perpendicular or substantially perpendicular to the central axis of the LED device; and
the second light passage hole is defined by an extremity of the second partition.

7. The pointer according to claim 6, wherein the first partition and the second partition are located closer to the LED device than an intermediate position between the LED device and the light emission hole.

8. The pointer according to claim 6, wherein the second light passage hole is larger than the first light passage hole.

9. The pointer according to claim 1, further comprising a second partition made of a porous material and extending across an entirety of the second chamber along the central axis of the LED device; wherein
the second partition includes a second light passage hole through which the light that has passed through the first light passage hole passes; and
the second light passage hole is disposed on the central axis of the LED device.

10. The pointer according to claim 9, wherein the second partition is thicker than the first partition.

11. The pointer according to claim 1, wherein an inner wall of the second chamber is light attenuating surface treated.

12. The pointer according to claim 1, wherein the case has a cuboid shape.

13. An inkjet printer comprising:
the pointer according to claim 1;
a bed on which a recording medium is to be placed;
an ink head disposed above the bed to discharge ink onto the recording medium placed on the bed;
a carriage equipped with the ink head and the pointer and being movable in a main scanning direction; and
a conveyor to move the recording medium in a sub-scanning direction perpendicular or substantially perpendicular to the main scanning direction; wherein
the light emission hole is provided on a lower surface of the pointer, and
the pointer and the bed are disposed such that WD≥P/2, where WD represents a distance between the bed and the lower surface of the pointer in an up-down direction, and P represents a length of the case of the pointer in the sub-scanning direction.

14. An inkjet printer comprising:
the pointer according to claim 1;
a bed on which a recording medium is to be placed;
an ink head disposed above the bed to discharge ink onto the recording medium placed on the bed;
a carriage equipped with the ink head and the pointer and being movable in a main scanning direction; and
a conveyor to move the recording medium in a sub-scanning direction perpendicular or substantially perpendicular to the main scanning direction; wherein
the pointer is disposed upstream of a downstream end of the carriage in the sub-scanning direction.

15. The inkjet printer according to claim 14, wherein the pointer is disposed upstream of a downstream end of the ink head in the sub-scanning direction.

16. The inkjet printer according to claim 15, wherein
the ink head includes a plurality of nozzles arranged in the sub-scanning direction to discharge ink onto the recording medium; and
the pointer is disposed between a most upstream one of the nozzles and a most downstream one of the nozzles in the sub-scanning direction.

17. The inkjet printer according to claim 16, wherein the pointer is disposed downstream of an intermediate position between the most upstream one of the nozzles and the most downstream one of the nozzles in the sub-scanning direction.

18. The inkjet printer according to claim 14, further comprising an operation panel through which settings are made and/or data is entered; wherein
the carriage includes a first side surface and a second side surface, the first side surface being located adjacent to the operation panel in the main scanning direction, the second side surface being located opposite to the operation panel in the main scanning direction; and
the pointer is attached to the first side surface.

19. The inkjet printer according to claim 14, wherein the conveyor is configured to move the bed in the sub-scanning direction.

20. The inkjet printer according to claim 14, wherein the pointer and the bed are disposed such that WD≥P/2, where WD represents a distance between the bed and a lower surface of the pointer provided with the light emission hole in an up-down direction, and P represents a length of the case of the pointer in the sub-scanning direction.
